(19) United States
(12) Patent Application Publication
(10) Pub. No.: US 2006/0029006 A1
(43) Pub. Date: Feb. 9, 2006

(54) Inverse multiplex framing

(75) Inventor: Zeev Oster, Modiin (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: SPEDIANT SYSTEMS LTD.

(21) Appl. No.: 10/913,544

(22) Filed: Aug. 9, 2004

(51) Int. Cl. H04L 5/22

(52) U.S. Cl. 370/299

(57) ABSTRACT

A system and method for coordinating data communication especially applicable to inverse multiplex (IMUX) systems. A fixed portion of transmitted data is dedicated to overhead data. During link start-up, receiver synchronization is aided by the transmission of a fixed data pattern in the user data and contrasting data in the overhead data. Changes in IMUX configuration, such as changes in the set of links participating in the IMUX, are mediated via commands that allow fast reconfiguration during start-up or in the event of link failure (“Panic Change”), or continued error-free transmission of data during planned reconfigurations (Sync Change).

This is a continuation-in-part of U.S. Provisional Patent Application No. 60/449,012, filed Sep. 2, 2003

### FIELD AND BACKGROUND OF THE INVENTION

The present invention relates to an inverse multiplex framing system, and, more particularly, to a system for initializing, controlling and coordinating data transmission via communication links.

In digital communication systems, timing is of critical importance because each bit has meaning only as it relates to its time position within a data stream. An error in timing can cause a bit value to be sampled too early or too late, in which case the bit will be misread, or, if the timing error is large enough to encroach upon the time frame of another bit, the wrong bit will be read.

In a channel that carries a stream of bits, it is therefore necessary to establish timing relationships for the stream so that the bits are interpreted clearly.

In one familiar prior-art form of asynchronous communication, for example, each character is transmitted independently, and carries the timing information that the receiver needs to interpret the bits properly. Between characters the channel is held in one state, known as “space”, and the beginning of a character is indicated by a transition from the space state to the “mark” state. This initial mark state is known as the “start bit”. Because the time allotted to the transmission of each bit is known, and only a limited number of bits are transmitted in each character, the receiver can use a local timing device of limited accuracy to decide when to sample each bit. At the end of the transmission of the character the channel is returned to the space state until a new character is to be transmitted. This final space state is known as the “stop bit”.

The above-described asynchronous transmission scheme suffers from the inefficiency of having to include the start and stop bits for each character. If each character includes eight bits plus one start bit and one stop bit, and the channel is operating at full capacity, only 80% of transmission time is available for the intended payload, or user, data, the other 20% being used to transmit start and stop bits.

Synchronous transmission schemes do not suffer from this inefficiency, but require more sophistication to allow the receiver to establish and maintain proper timing. In synchronous data communication systems data units, such as bytes, are sent one after another with no intervening start or stop bits. Unless the transmitter and receiver both have access to the same clock, there must be a way for the receiver to maintain synchrony with the transmitter despite any variations in the receiver clock relative to the transmitter clock. This synchronization can be maintained by having the receiver synchronize its clock according to whatever transitions occur in the transmitted data. Provided that the time separation between transitions is small enough that the receiver clock does not vary, relative to the transmitter clock, by half the time allocated to a single bit it is possible for the receiver to synchronize the receiver clock to the transmitter clock unambiguously.

In digital communication systems, data are transmitted as symbols, such as bits. Symbols may be organized into groups, referred to herein as datagrams, such as bytes.

A bit takes on one of two possible values, such as “true” or “false”, “1” or “0”, “mark” or “space”. Pairs of bits having opposite values, such as “true” and “false”, “1” and “0”, “mark” and “space”, are said to be of opposite polarity.

Data structures, including, but not limited to, bits, bytes and datagrams, may be dealt with as strings. As used herein, a string of data structures is a sequence of data structures of the same type, such as a string of datagrams. As used herein, unless otherwise specified, the term string refers to a string of datagrams. The length of a string of data structures is the number of such data structures in the string. A string may have a length of any whole number. Thus, a string having a length of one is considered herein to be a string.

As used herein, unless otherwise noted, the “position” of a data structure refers to the place the data structure occupies within the order of an ordered collection of data, and not necessarily to the spatial position of any physical entity representing the data structure. Data structures, for this purpose, include, but are not limited to, bits, bytes, datagrams, frames, multi-frames and super-frames. Ordered collections of data, for this purpose, include, but are not limited to, serial data streams, parallel data streams, and data files.

In some communication systems, such as the TDIM (Time Division Inverse Multiplexing, also referred to as IMUX, or inverse multiplex) system described in published U.S. patent application 2003/0152112, which is incorporated by reference for all purposes as if fully set forth herein, and illustrated schematically in FIG. 1, it is necessary to keep multiple communication links 16 carrying data from a transmitter, in this case central office (CO) transmitter 10 to a receiver, in this case customer premises equipment (CPE) receiver 12, substantially synchronized with each other and to compensate for any differences in latency between links 16. Similarly, it is necessary to keep multiple communication links 76 carrying data from CPE transmitter 72 to CO receiver 70 substantially synchronized with each other and to compensate for any differences in latency between links 76. For brevity, the discussion herein focuses primarily on transmission of data in a single direction, from CO 24 to CPE 26, via links 16, and, unless otherwise noted, transmission of data from CPE 26 to CO 24, via links 76, occurs in a similar fashion. In the TDIM system of U.S. 2003/0152112, such synchronization is necessary because multiple physical links 16 are used, according to demand for data throughput capacity, to form a virtual link, or “bundle”, having a data throughput capacity substantially equal to the sum of the data throughput capacities of the individual links 16 included in the bundle, and re-assembly of data by CPE receiver 12 is done according to the time position of each datagram on each link 16 included in the bundle.

When, because of noise or other disturbance, synchronization is lost, it is important that synchronization be re-established quickly.

There is thus a widely recognized need for, and it would be highly advantageous to have, a system and method for establishing synchronization of data links particularly suited for TDIM data communication systems.

### SUMMARY OF THE INVENTION

According to the present invention there is provided a communication system including: (a) a first receiver for receiving datagrams grouped in frames, the first receiver including: (i) a recognizer for recognizing the datagrams; and (ii) a frame regulator, the recognizer operative to recognize a first string of the datagrams having a first predetermined pattern, the recognizer further operative to recognize a deviation, from the first pattern, of a second string of the datagrams, the recognizer further operative to recognize a third string of the datagrams having a second predetermined pattern, the recognizer further operative to recognize a deviation, from the second pattern, of a fourth string of the datagrams, the first receiver operative to set the frame regulator according to a time of arrival of one of the strings of the datagrams and according to a count of the datagrams between the second string and the fourth string, the frame regulator being operative to identify a position of one of the datagrams within one of the frames.

Preferably, in the system, the first pattern and the second pattern are identical.

Alternatively, in the system, the first pattern and the second pattern differ from each other.

Preferably, in the system, the datagrams include bits, and at least one of the patterns includes a plurality of contiguous groups of the bits, all the groups having a like number of bits, all the bits within any group having like polarity, consecutive groups of the bits alternating in polarity.

Preferably, in the system, the first receiver further includes: (iii) a datagram counter operative to perform the count of the datagrams, and the first receiver is operative to initialize the datagram counter according to a time of the recognition of the second string.

Preferably, in the system, the first receiver further includes: (iii) a frame length register, and the first receiver is operative to set the frame length register according to the count of the datagrams.

Preferably, the system further includes: (b) a first transmitter; (c) a second receiver, and (d) a second transmitter, and the first receiver, after receiving the fourth string, is operative to cause the first transmitter to transmit a confirmation message, and the second receiver, after receiving the confirmation message, is operative to cause the second transmitter to transmit user data to the first receiver.

For example, in the schematic illustration of FIG. 6, it can be considered, for synchronization of a CO-to-CPE link 16, that the first receiver corresponds to CPE IMUX receiver 12, the first transmitter corresponds to CPE IMUX transmitter 72, the second receiver corresponds to CO IMUX receiver 70, and the second transmitter corresponds to CO IMUX transmitter 10. For synchronization of a CPE-to-CO link 76, the first receiver corresponds to CO IMUX receiver 70, the first transmitter corresponds to CO IMUX transmitter 10, the second receiver corresponds to CPE IMUX receiver 12, and the second transmitter corresponds to CPE IMUX transmitter 72. FIG. 6 is only an example, and other configurations having similar function are within the scope of the present invention.

Preferably, in the system, the first string, the second string, the third string and the fourth string are transmitted by the second transmitter.

Preferably, in the system, at least one of the frames includes at least one overhead datagram, and the second string is within at least one of the at least one overhead datagrams, and the fourth string is within at least one of the at least one overhead datagrams.

Preferably, in the system, the first receiver further includes: (iii) an inverse multiplex receiver.

According to the present invention there is provided a method of synchronizing a receiver, of a communication system, that receives frames of datagrams, including the steps of: (a) recognizing a first string of the datagrams having a first predetermined pattern; (b) recognizing a deviation, from the first pattern, of a second string of the datagrams; (c) recognizing a third string of the datagrams having a second predetermined pattern; (d) recognizing a deviation, from the second pattern, of a fourth string of the datagrams, and (e) identifying a position of a datagram within a frame according to a time of arrival of one of the strings of datagrams and according to a count of the datagrams between the second string and the fourth string.

Preferably, the method further includes the step of: (f) receiving the datagrams in an inverse multiplexed fashion.

According to the present invention there is provided a communication system including a receiver operative to receive datagrams grouped in frames, at least one frame including at least one overhead datagram, and wherein the receiver is further operative to receive at least one command via at least one of the at least one overhead datagram.

Preferably, in the system, the at least one command is distributed among a plurality of the overhead datagrams.

Preferably, in the system, each of the at least one overhead datagram is at a respective predetermined position within a frame.

Preferably, in the system, at least one overhead datagram includes a frame number.

Preferably, in the system, the receiver is further operative to receive a cyclic redundancy code for the at least one command via one of the at least one overhead datagram.

Preferably, in the system, the receiver is operative to receive a cyclic redundancy code for user data via at least one of the at least one overhead datagram.

Preferably, in the system, the receiver is operative to receive the datagrams in an inverse multiplexed fashion.

Preferably, in the system, one of the at least one command is a marker command, the receiver operative to use the marker command to measure a latency of a corresponding inverse multiplex link.

Preferably, in the system, one of the at least one command indicates which algorithm, from a predetermined group of algorithms, is to be used for calculating a parameter related to the communication system.

Preferably, in the system, the parameter includes a time slot vector.

Preferably, in the system, one of the at least one command indicates which time division multiplex protocol, from a predetermined group of time division multiplex protocols, is to be used on a link.

Preferably, in the system, one of the at least one command indicates a data rate to be used on a link.

Preferably, in the system, the receiver is operative to accept the at least one command only if the receiver receives the at least one command identically a predetermined number of times greater than one.

According to the present invention there is provided a method for communication including the steps of: (a) receiving datagrams grouped in frames, at least one frame including at least one overhead datagram, and (b) receiving at least one command via at least one of the at least one overhead datagram.

Preferably, the method further includes the step of: (c) receiving the datagrams in an inverse multiplexed fashion.

According to the present invention there is provided a system including: (a) a first device; and (b) a second device communicating with the first device via at least one link, wherein the first device is operative to transmit a command specifying a parameter related to the communicating, and wherein the second device, after having received the command, is operative to operate according to the parameter and transmit a confirmation message operative to confirm receipt by the second device of the command and wherein the first device, after having received the confirmation message, is operative to operate according to the parameter.

Preferably, in the system, the parameter includes a list of the at least one link participating in an inverse multiplex system.

Preferably, in the system, the second device is operative to compute, using the list of the at least one link, a time slot vector operative to organize reception of data from the at least one link.

Preferably, in the system, the command includes a bitmap.

According to the present invention there is provided a method for coordinating communication between a first device and a second device via at least one link, the method including the steps of: (a) the first device transmitting a command specifying a parameter related to the communication; (b) the second device receiving the command and operating according to the parameter; (c) the second device transmitting a confirmation message operative to confirm receipt by the second device of the command; and (d) the first device receiving the confirmation message and operating according to the parameter.

Preferably, in the method, the parameter includes a list of at least one link participating in an inverse multiplex system.

According to the present invention there is provided a system including: (a) a first device; and (b) a second device communicating with the first device via at least one link, wherein the first device is operative to transmit a command specifying a parameter related to the communicating, the first device repeating the transmission of the command until the first device has received a confirmation message operative to confirm receipt by the second device of the command, and wherein the second device, after having received the command, is operative to transmit the confirmation message, and wherein the first device, after having received the confirmation message, is operative to repeatedly transmit a countdown message including a countdown variable, with the countdown variable decremented upon each repetition of the transmission of the countdown message until the countdown variable has a first predetermined value, the first device subsequently being operative to transmit data according to the parameter.

Preferably, in the system, the second device is operative to receive at least one countdown message and the second device is subsequently operative to repeatedly transmit a reflex countdown message including a reflex countdown variable, with the reflex countdown variable decremented upon each repetition of the transmission of the reflex countdown message, until the reflex countdown variable has a second predetermined value, the second device subsequently operative to transmit data according to the parameter.

Preferably, in the system, the first device, upon receiving a reflex countdown message whose reflex countdown variable has the second predetermined value, is subsequently operative to receive data according to the parameter.

Preferably, in the system, the second device, upon receiving a countdown message whose countdown variable has the first predetermined value, is subsequently operative to receive data according to the parameter.

Preferably, in the system, the parameter includes a list of the at least one link participating in an inverse multiplex system.

Preferably, in the system, the second device is operative to compute, using the list of the at least one link, a time slot vector operative to organize reception of data from the at least one link.

Preferably, in the system, the command includes a bitmap.

According to the present invention there is provided a method for coordinating communication between a first device and a second device via at least one link, the method including the steps of: (a) the first device transmitting a command specifying a parameter related to the communication, the first device repeating the transmission of the command until the first device has received a confirmation message operative to confirm receipt by the second device of the command; (b) the second device receiving the command and transmitting the confirmation message; and (c) the first device receiving the confirmation message and the first device subsequently repeatedly transmitting a countdown message including a countdown variable, with the countdown variable decremented upon each repetition of the transmission of the countdown message until the countdown variable has a first predetermined value, the first device subsequently transmitting data according to the parameter.

Preferably, in the method, the parameter includes a list of at least one link participating in an inverse multiplex system.

### BRIEF DESCRIPTION OF THE DRAWINGS

The invention is herein described, by way of example only, with reference to the accompanying drawings, wherein:

FIG. 1 is a schematic illustration of an IMUX communication system;

FIG. 2 is a schematic diagram of the relationships between mini-frames, frames, and multi-frames according to the present invention;

FIG. 3 is a schematic diagram of the synchronization data pattern used in an embodiment of the present invention;

FIG. 4 is a schematic illustration of message flow as a function of time during a Panic Change in an embodiment of the present invention;

FIG. 5 is a schematic illustration of message flow as a function of time during a Sync Change in an embodiment of the present invention;

FIG. 6 is a schematic illustration of an IMUX communication system incorporating synchronization according to the present invention;

FIG. 7 is a schematic illustration showing, in greater detail, an IMUX receiver according to the present invention.

### DESCRIPTION OF THE PREFERRED EMBODIMENTS

The present invention teaches a frame structure, and overhead data to be transmitted within this frame structure, such as to facilitate the process of link synchronization, and, for an IMUX system, the processes of link addition and link removal.

In the TDIM system of U.S. 2003/0152112, a datagram is a single byte, although the present invention is also applicable to systems wherein datagrams have other sizes.

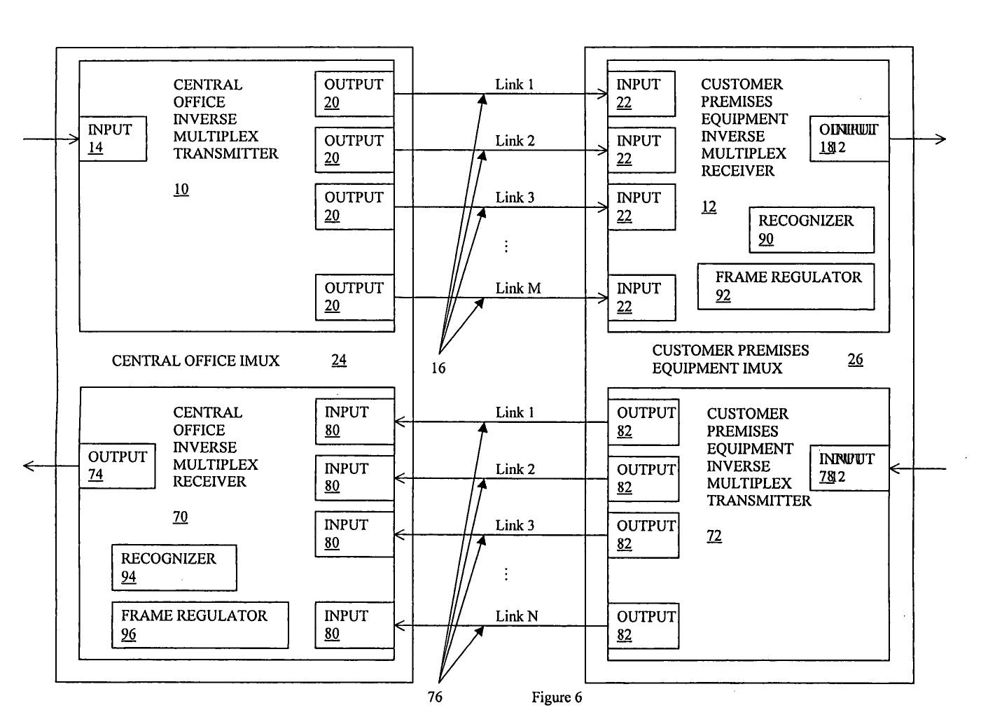

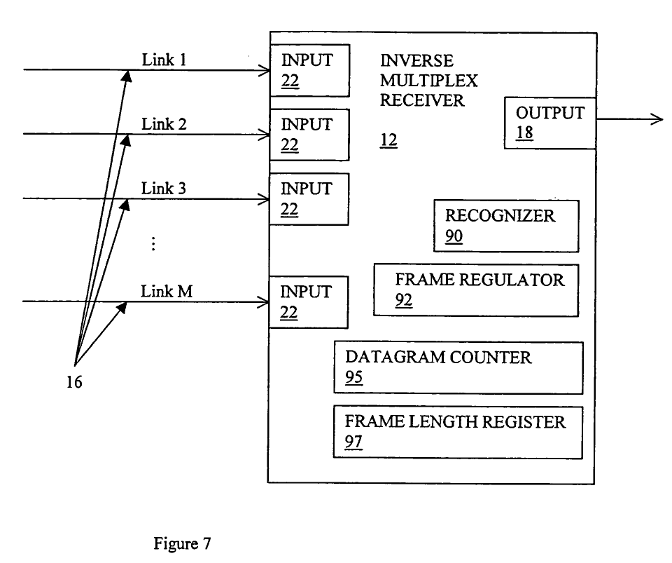

In a communication system according to the present invention, synchronization of receivers 12 and 70 is maintained by frame regulators 92 and 96, respectively (see FIGS. 6 and 7), frame regulators 92 and 96 each being operative to identify, or keep track of, the position, within the frame structure, of incoming datagrams, allowing datagrams to be interpreted according to their position within the frame structure. Frame regulators 92 and 96 may be implemented in software or in hardware. A hardware implementation of a frame regulator 92 or 96 would typically make use of devices such as a datagram counter 95 and a frame length register 97 (see FIG. 7). The use of frame regulators 92 or 96 of any type is within the scope of the present invention.

In the present invention, synchronization is accomplished with the aid of a frame structure including frame overhead data. The frame overhead data are used for synchronization and management of the IMUX system. Although the present invention was developed for TDIM systems using Digital Subscriber Line (DSL) links, the present invention is also applicable to other types of systems and other types of links.

Mini-Frame

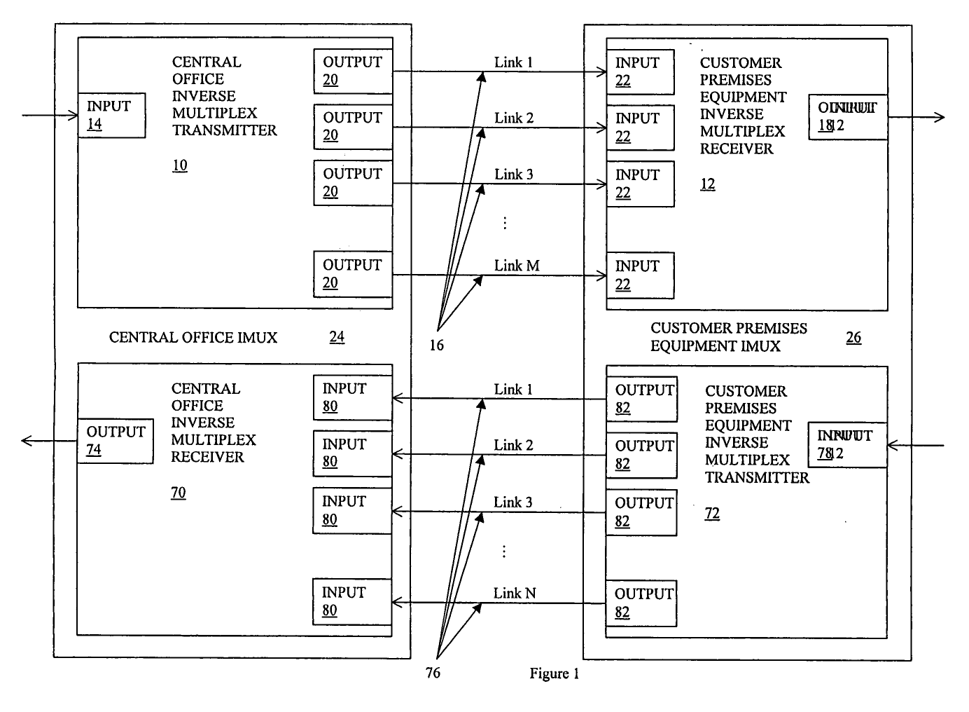

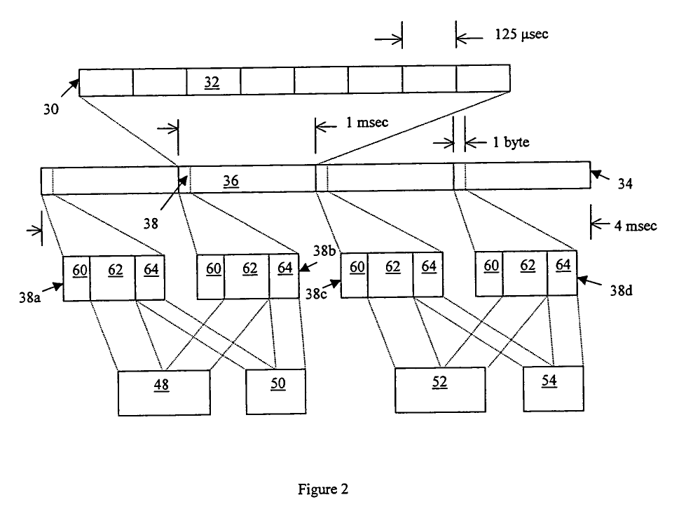

Referring now to the drawings, FIG. 1 illustrates schematically an inverse multiplex system according to U.S. 2003/0152112, FIG. 2 illustrates schematically the frame structure used in one preferred embodiment of the present invention, and FIG. 6, similar to FIG. 1, illustrates schematically a preferred embodiment of an inverse multiplex system that further includes synchronization according to the present invention. FIG. 7 illustrates schematically, in more detail, an IMUX receiver according to the present invention.

In this preferred embodiment, a datagram is a single byte, although, as stated above, the present invention is also applicable to systems wherein datagrams have other sizes. In this preferred embodiment, data are organized into mini-frames 32. Each mini-frame 32 has a fixed time duration. In this preferred embodiment, a duration of 125 μsec for a single mini-frame 32 has been chosen, although other durations are possible, and are within the scope of the present invention. In this preferred embodiment a datagram is a single byte, although datagrams of other sizes may be chosen, and are within the scope of the present invention. A byte is a group of bits that are treated as a unit. In this discussion, a byte consists of eight bits, but bytes having other sizes are possible, and are within the scope of the present invention. The number of bytes in each mini-frame 32 varies from link 16 to link 16 according to the rate of each link 16, but the number of bytes in each mini-frame 32 is always a whole number. Therefore, in this preferred embodiment, the data rate of each link 16 is constrained to be an integer multiple of 64,000 bits per second (64 kbps). The temporal location of each byte within a mini-frame 32 determines which link 16 will transport the byte. The time slot associated with each byte is determined by a time-slot (TS) vector known to both CO transmitter 10 and CPE receiver 12. The TS vector is chosen, as described in U.S. 2003/0152112, in a manner that assigns bytes to each link 16 substantially in proportion to the speed of that link 16, so as to make efficient use of all available links 16. Any of a variety of algorithms may be used to determine the TS vector, however, both CO transmitter 10 and CPE receiver 12 must use algorithms that produce identical TS vectors. This is easily accomplished by having both CO transmitter 10 and CPE receiver 12 utilize identical algorithms for determining the TS vector.

Frame

In FIG. 2 several mini-frames 32 are shown combined into a single frame 30. A multi-frame 34 includes several frames 36. Frame 30 and frame 36 are two schematic illustrations of the same concept. In this preferred embodiment, a frame 30 includes 8 mini-frames 32 and therefore has a duration of 1 msec. The start of a frame 30 coincides with the start of the first mini-frame 32 of that frame 30. A portion of each frame 36 transmitted via each link 16 is dedicated to overhead data 38. In this preferred embodiment, the initial byte of each frame 36 transmitted via each link 16 is dedicated to overhead data 38. Overhead data 38 facilitate synchronization of links 16 and transfer of commands and other administrative information between devices 10 and 12 communicating via the IMUX system.

Although this preferred embodiment utilizes a single overhead datagram 38 at the start of each frame 36, other numbers of overhead datagrams 38 per frame 36, and other placements of overhead datagrams 38 within frames 36, so long as those placements are known to receiver 12, are possible, and within the scope of the present invention.

As used herein, the notation “Ox” indicates that what follows is a hexadecimal number. For example, 0x15 represents the hexadecimal number 15, which corresponds to 21 in the decimal system of numbers, and 0x0E represents the hexadecimal number 0E, which corresponds to 14 in the decimal system of numbers.

As used herein, the notation x[n:m] represents bits n through m, inclusive, of byte x, with n being the most significant of the designated bits, and with m being the least significant of the designated bits. The most significant bit of an eight-bit byte is indicated by 7, and the least significant bit by 0. For example, q[4:3] represents the middle two bits of byte q.

As used herein, the abbreviation “Tx” refers to “transmit”, and the abbreviation “Rx” refers to “receive”.

Commands used in this embodiment of the present invention are summarized in Table 1, and are presented in more detail in this description where relevant. Each command is associated with an “operation code”, abbreviated as “op. code”.

TABLE 1
Op.

| Code | Name | Argument field | Remarks |
|---|---|---|---|
| 0x00 | Null | 0x00 | Transmitted whenever there is |
| | | | no other op. code to send |
| 0x01 | Vector | The version identifier of | |
| | Version | the vector calculation | |
| | | algorithm | |
| 0x02 | TDM Type | 7:6 - TDM number | In this embodiment: |
| | | 5:0 - TDM Type | The two bit TDM number is |
| | | | always ‘00’. |
| | | | The TDM type is 0x00 for DS1 |
| | | | and 0x20 for E1. |
| 0x03 | TDM Rate | 7:6 - TDM number | In this embodiment the TDM |
| | | 5:0 - TDM Rate | number is always ‘00’. |
| | | | The TDM rate is the actual TDM |
| | | | rate; the units of this field for |
| | | | (fractional) E1/DS1 are bytes. |
| | | | The TDM Rate is 0 if there is no |
| | | | TDM in this IMUX link |
| 0x04 | Panic Change | Bitmap of the links that | Sent three times. |
| | | will be part of the IMUX | |
| | | after the change | |
| 0x05 | Sync Change | Bitmap of the links that | |
| | | will be part of the IMUX | |
| | | after the change | |
| 0x06 | New Vector | Countdown variable | |
| | | indicating the number of | |
| | | super-frames that will be | |
| | | sent before the sender will | |
| | | start using the new TS | |
| | | vector for transmission | |
| 0x07 | Marker-CRC | CRC-8 of the IMUX | This command is sent via all |
| | | traffic. The CRC | links at the same time. This |
| | | generator polynomial is: | command serves two purposes: |
| | | X⁸ + X² + X + 1, and is | First - the deframer uses this op. |
| | | calculated on the entirety | code to synchronize all links and |
| | | of the data of the last | in this way compensates for |
| | | super-frame. | differences in latency among |
| | | | them. Second - detection of data |
| | | | errors using the CRC |
| | | | information. |
| | | | This command is sent in the |
| | | | initial multi-frame of every |
| | | | super-frame, i.e. every 12 msec. |
| 0xFF | Frame Sync | 7 - Sync indication bit, ‘1’ | This command is sent during |
| | | for synchronized and ‘0’ | link synchronization. The |
| | | for not synchronized. | argument field indicates if the |
| | | 6:0 - The number of the | sender is already synchronized, |
| | | link, as numbered by the | and the link number. |
| | | sender. | The user data transmitted via a |
| | | | link undergoing synchronization |
| | | | are 0x00 and 0xFF alternately. |

Multi-Frame

A multi-frame 34 includes a fixed number of frames 36. In this preferred embodiment a multi-frame 34 includes 4 frames 36 and therefore a multi-frame 34 has a duration of 4 msec. Organizing frames 36 into multi-frames 34 enables the use of a command structure that has a length larger than 8 bits, with portions of a command being distributed among several overhead data portions 38. In this preferred embodiment, the overhead data portions 38 of a multi-frame include a single complete command.

Super-Frame

A super-frame includes a fixed number of multi-frames 34. In this preferred embodiment a super-frame includes 3 multi-frames 34 and therefore contains 3 commands, and has a duration of 12 msec. The command in the initial multi-frame 34 of a super-frame is a Marker-CRC command (op. code 0x07), as described in Table 1, and the remaining two multi-frames 34 each include a copy of an executable command, the two copies of the executable command being identical to each other. If the two copies of the executable command are not identical to each other, receiver 12 assumes that there was an error in transmission of the executable command and the executable command is not executed. Although, in this preferred embodiment, executable commands are sent twice, other embodiments may include the transmission of executable commands any number of times, including transmitting executable commands just once, and such embodiments are included in the scope of the present invention.

Overhead Data Structure

FIG. 2 illustrates schematically the relationship of overhead data bytes 38 to op. code 48 and associated op. code CRC 50, and argument 52 and associated argument CRC 54. Op. code 48 and associated op. code CRC 50 are each spread across the first two overhead data bytes 38 of a multi-frame 34. Argument 52 and associated argument CRC 54 are each spread across the last two overhead data bytes 38 of a multi-frame 34.

In this preferred embodiment, the initial byte of any frame transmitted via each link 16 (or 76) is dedicated to overhead data 38. Each overhead data byte 38 includes a two-bit frame number 60, four op.code/argument bits 62, and two CRC (cyclic-redundancy code) bits 64. A multi-frame 34 includes four overhead data bytes 38, two of which, 38a and 38b, include an 8-bit op. code 48 and an associated 4-bit op. code CRC 50, and the remaining two of which, 38c and 38d, include an 8-bit argument (arg) 52 and a 4-bit argument CRC 54. Bits from these two pairs of overhead data bytes 38 are re-assembled to form the op.code 48, argument 52, and CRCs 50 and 54 in a manner described below. Argument 52 serves to supply supplementary information related to op. code 48, and interpretation of argument 52 varies according to op. code 48, as indicated in Table 1.

The frame number 60, located in the most significant two bits of every overhead data byte 38, denotes, in binary notation, the position of the frame 36 within the multi-frame 34, with 00 denoting the initial frame 36 and 11 denoting the final frame 36 of each multi-frame 34. The frame number 60 aids in recognizing the boundaries of multi-frames 34, and detection of incorrect frame numbers 60 aids in recognizing failure of a link 16.

The middle four bits 62 of each overhead data byte 38 are information bits (Op.code[7:4], Op.code[3:0], Arg[7:4] or Arg[3:0]), the meaning of which depends upon the position of each frame 36 within multi-frame 34, as explained below.

The least significant two bits 64 of each overhead data byte 38 are CRC bits (CRC[3:2] or CRC[1:0]). There is a four-bit CRC 50 associated with the Op. code field 48 and an independent four-bit CRC 54 associated with the Arg field 52. These CRCs 50 and 54 aid in the detection of corruption of the Op. code 48 and Arg 54 fields during transmission. These CRCs 50 and 54 are determined by the same algorithm as the E1 CRC, using the generator polynomial X⁴+X+1.

Bits from zeroth overhead byte 38a and first overhead byte 38b of a multi-frame 34 are combined to form an 8-bit op. code 48 and an associated 4-bit op. code CRC 50. The middle four bits 62 of zeroth overhead byte 38a contribute the most significant four bits of op. code 48. The middle four bits 62 of first overhead byte 38b contribute the least significant four bits of op. code 48. The least significant two bits 64 of zeroth overhead byte 38a contribute the most significant two bits of op. code CRC 50. The least significant two bits 64 of first overhead byte 38b contribute the least significant two bits of op. code CRC 50.

Similarly, bits from second overhead byte 38c and third overhead byte 38d of a multi-frame 34 are combined to form an 8-bit argument 52 and an associated 4-bit argument CRC 54. The middle four bits 62 of second overhead byte 38c contribute the most significant four bits of argument 52. The middle four bits 62 of third overhead byte 38d contribute the least significant four bits of argument 52. The least significant two bits 64 of second overhead byte 38c contribute the most significant two bits of argument CRC 54. The least significant two bits 64 of third overhead byte 38d contribute the least significant two bits of argument CRC 54.

In this preferred embodiment, links can include, but are not limited to, DSL links, time-division multiplex (TDM) links, such as E1 links, and other digital communication links. The command structure used in this preferred embodiment, as summarized in Table 1, includes commands, such as TDM Type (op. code 0x02) and TDM Rate (op. code 0x03), suitable to aid in management of TDM links.

Synchronization

Each one of the links 16 that participates in the IMUX, or that is a candidate for participation, transmits a Marker-CRC command (op. code 0x07), synchronized to transmissions of other links in the system, in the overhead data portion 38 of the first multi-frame 34 of each super-frame. Links 16 that are not yet participating in the IMUX transmit a Marker-CRC command (op. code 0x07) in the overhead data portion 38 of the first multi-frame 34 of each super-frame, Frame-Sync commands (op. code 0xFF) identical to each other in the overhead data portions 38 of each of the remaining two multi-frames 34 of each super-frame, and a repeating pattern of alternating 0x00 and 0xFF in the non-overhead portions, i.e., the portions which, where the link 16 in actual use by a user, would carry user data. Although the synchronization pattern is not actual user data, it is, for convenience, herein referred to as such.

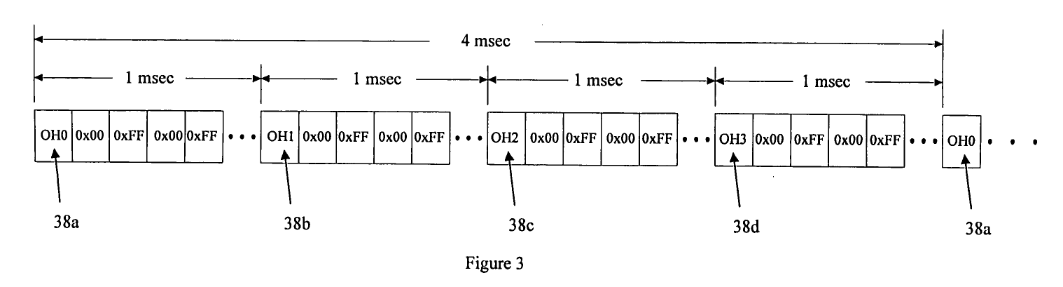

FIG. 3 illustrates schematically the data transmitted via a link 16 during synchronization. Table 2 summarizes the overhead data transmitted during synchronization. Bits marked “x” in the Table 2 are variable. See the descriptions of the Marker-CRC command (op. code 0x07) and the Frame Sync command (op. code 0xFF) in Table 1. Data listed under Marker-CRC in Table 2 are transmitted in the overhead portions 38 of the first multi-frame 34 of each super-frame. Data listed under Frame Synchronization are transmitted in the overhead portions 38 of the remaining two multi-frames 34 of each super-frame. The fifth bit (counting from the zeroth, least significant bit) of the second byte 52 of the Frame Synchronization command (op. code 0xFF), which corresponds to the seventh (most significant) bit of the argument of the Frame Synchronization command (op. code 0xFF) (see description of Frame Sync command (op. code 0xFF) in Table 1, and the above description of how bits from overhead data bytes 38 are combined to form argument bytes 52), is 0 if the CPE receiver input 22 associated with the CO transmitter output 20 transmitting the Frame Sync command (op. code 0xFF) has not yet been synchronized, and is 1 if CPE receiver input 22 has been synchronized. The synchronization process is discussed more fully below.

TABLE 2

| Overhead Byte Number, | Marker-CRC, | Frame Synchronization, |
|---|---|---|
| decimal (binary) | binary | binary |
| 0 (00) | 00000010 | 00111101 |
| 1 (01) | 01011101 | 01111100 |
| 2 (10) | 10xxxxxx | 100xxxxx / 101xxxxx |
| 3 (11) | 11xxxxxx | 11xxxxxx |

During synchronization, a first task of CPE receiver 12 is to recognize byte alignment. This is accomplished with the aid of the 0x00, 0xFF pattern in the user data. Other patterns may be used instead of the 0x00, 0xFF pattern to aid in byte alignment, and the use of other patterns is within the scope of the present invention.

Recognition of bytes, and patterns of bytes, is performed by recognizers 90 and 94 (FIGS. 6 and 7), which compare incoming bytes with patterns that are generated or stored in CPE receiver 12 and CO receiver 70, respectively. Recognizers 90 and 94 may be implemented in software or in hardware. The use of recognizers 90 and 94 of any type is within the scope of the present invention.

A second task of CPE receiver 12 is frame 36 and multi-frame 34 alignment. CPE receiver 12 searches for a zeroth overhead byte 38a, designated OHO, and having 000000 as its most significant six bits, in marker multi-frame 34. Having found a zeroth overhead byte 38a, CPE receiver 12 then searches for a first overhead byte 38b, designated OH1, and having 010111 as its most significant six bits, while counting the number of bytes between zeroth overhead byte 38a and first overhead byte 38b. The number of bytes between zeroth overhead byte 38a and first overhead byte 38b, plus one, is the frame length, in bytes, of this link 16. The alternating 0x00, 0xFF pattern in the user data is particularly advantageous for recognition of overhead bytes 38, especially if a frame 36 always includes an even number of bytes and the pattern starts with 0x00 immediately after each overhead byte 38, in which case the final byte of each frame will be 0x00. Hence, any byte following a 0x00 that is not 0xFF is easily recognized as an overhead byte 38. Because of the initial zero bit in the frame numbers 60 of zeroth overhead byte 38a and first overhead byte 38b, zeroth overhead byte 38a and first overhead byte 38b of any frame 36 differ from 0xFF, simplifying the tasks of synchronization and determination of frame length. In this preferred embodiment, CPE receiver 12 uses the frame length to determine the correct times at which to find all other overhead data bytes 38 of the Marker-CRC command (op. code 0x07) and the Frame-Sync command (op. code 0xFF). A side-effect is that the IMUX determines the link number, as the link number is included in the Frame-Sync argument field 52.

A third task in synchronization is to compensate for any differences in latency among links 16. CPE receiver 12 does this using the Marker-CRC command (op. code 0x07). Note that, although in this embodiment CPE receiver 12 compensates for any differences in latency among links 16 using a command, the Marker-CRC command (op. code 0x07), that includes a CRC, a CRC is not vital for compensating for any differences in latency among links 16, and a marker command not including a CRC may be used for compensating for any differences in latency among links 16.

To complete the synchronization process, in this embodiment, CPE receiver 12 detects one more correct super-frame synchronized to the rest of the synchronized links 16. When synchronization is complete the sync indication bit in the argument field 52 of the Sync-Frame command (op. code 0xFF) is set. CO transmitter 10 repeats sending the Frame-Sync command (op. code 0xFF) and does not add the link 16 to the IMUX until the CO side has received indication of synchronization from the CPE side. The synchronization indication can be receipt of a Frame-Sync command (op. code 0xFF) with the sync indication bit in the argument field 52 set to “1” or receipt of a correct command other than a Frame-Sync command (op. code 0xFF).

In the event of any error in the synchronization process, e.g., incorrect op. code CRC 50, incorrect argument CRC 54, incorrect location of the overhead data byte 38 in a frame 36, incorrect command in the super-frame, or failure of synchronization between a link 16 and other links 16, etc., the CO IMUX starts the synchronization process again from the beginning.

Link Failure

For the sake of brevity, the following discussion of link failure and recovery focuses on a CO to CPE link 16, although it will be apparent to those skilled in the art that similar considerations apply to a CPE to CO link 76. A link 16 is, in this embodiment, considered to have lost synchronization and failed after four consecutive errors in op. code CRC 50 or argument CRC 54, or four consecutive errors in the two-bit frame number 60. Other criteria may be used to define failure of a link 16, and the use of such other criteria is within the scope of the present invention.

When CPE IMUX 26 detects failure of a CO to CPE link 16 CPE IMUX 26 sends all ones in the user data on a corresponding CPE to CO link 76 until CO IMUX 24 recognizes the reception of all ones as a sign of failure and removes the failed link 16 from use, and then the CO IMUX 24 tries to synchronize the link 16 from the beginning, as described above.

Changes

In this embodiment, changes in link configuration are made by CO IMUX 24 using commands transmitted via overhead data 38. A change may be either a “Panic Change” or a “Sync Change”, as described below. In general, CPE IMUX 26 echoes commands back to CO IMUX 24.

The Panic Change command (op. code 0x04) and the Sync Change command (op. code 0x05) each specify, in their respective arguments, a list of links 16 to participate in an IMUX bundle, the list being in the form of a bitmap. Each bit in the bitmap represents a link 16 that is a potential participant in the bundle, and the value of each bit specifies whether or not the corresponding link 16 is actually to participate in the bundle. For example, an eight-bit bitmap, with bits numbered, starting from zero, from the rightmost, least significant bit, and having binary representation 11000001, indicates that the bundle is to include the zeroth, sixth and seventh links 16, and not the first, second, third, fourth or fifth links 16.

Panic Change

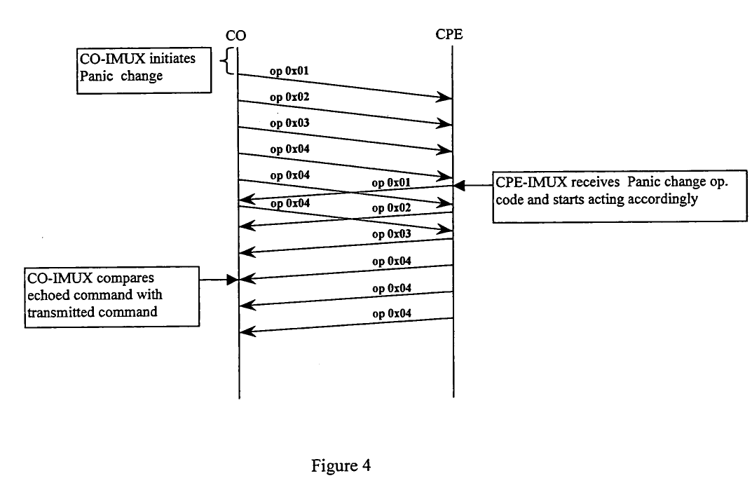

FIG. 4 schematically illustrates information flow during a panic change.

CO IMUX 24 initiates a panic change in the event that a link 16 fails and must be removed from the bundle, or in the event that there are no links 16 in the bundle and it is necessary to add links 16. A panic change is fast but does not assure a “hitless” change, that is, that the change will occur without transmission errors caused by lack of coordination among the links 16 that make up the bundle. Preferably, a panic change is performed only when any affected links 16 are not carrying user data.

CO IMUX 24 sends the following commands to CPE IMUX 26 to initiate a panic change:
(1) Vector Version command (op. code 0x01), arg=[vector_version]. Sent only during link initialization;
(2) TDM Type command (op. code 0x02), arg=[tdm_type]. Sent only during link initialization;
(3) TDM Rate command (op. code 0x03), arg=[tdm_rate]. Sent only during link initialization;
(4) Panic Change command (op. code 0x04), arg=[participating_links]. Sent 3 times to ensure that CPE IMUX 26 receives the op. code. The argument is a list, in the form of a bitmap, of the links 16 that will be part of the IMUX after the change.

CO IMUX 24 will start working according to the new situation, i.e., link participation and TDM configuration, at the beginning of the next mini-frame, i.e. a maximum delay of 125 μsec.

CPE IMUX 26, upon receiving the Panic Change command (op. code 0x04) and decoding the remote participating links, and the vector version, TDM types and TDM rates, if commands associated with these values have been sent, sends the following commands to CO IMUX 24:
(1) Vector Version command (op. code 0x01), arg=[vector_version]. Sent only as reply to corresponding CO op. code;
(2) TDM Type command (op. code 0x02), arg=[tdm_type]. Sent only as reply to corresponding CO op. code;
(3) TDM Rate command (op. code 0x03), arg=[tdm_rate]. Sent only as reply to corresponding CO op. code;
(4) Panic Change command (op. code 0x04), arg=[participating_links]. Sent 3 times to ensure that CO-IMUX 24 receives the op. code. The argument is a list, in the form of a bitmap, of the links 16 that will be part of the IMUX after the change.

CPE IMUX 26 begins to work according to the new situation, i.e., link participation and TDM configuration, at the beginning of the first possible mini-frame, allowing for the possibility that CPE IMUX 26 will need some time for internal calculations.

CO IMUX 24, upon receiving the Panic Change command (op. code 0x04) and decoding the participating links, and the vector version, TDM types and TDM rates, if commands associated with these values have been sent, compares the remote information to it own and starts a new panic change if there is a difference.

Sync Change

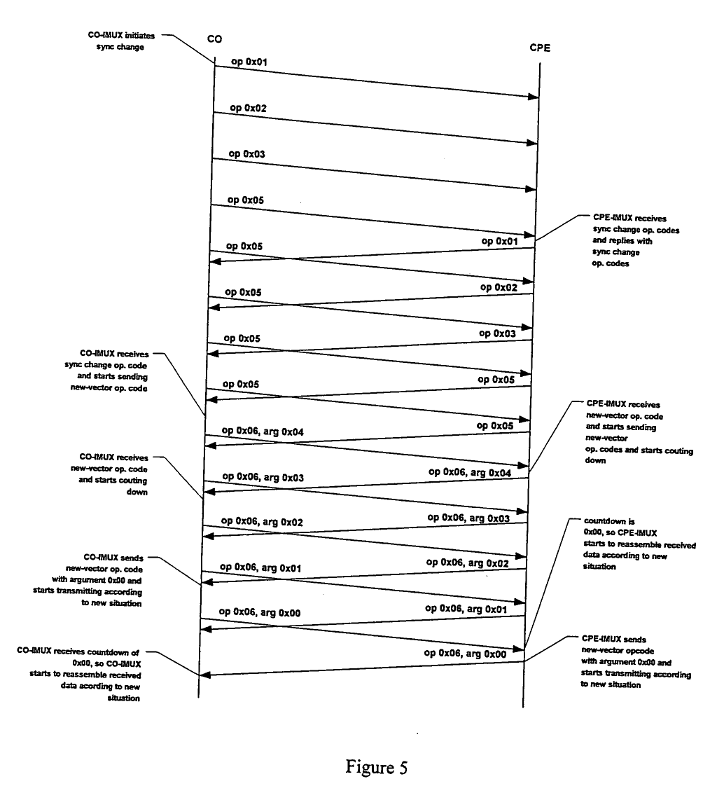

FIG. 5 schematically illustrates information flow during a sync change. A sync (synchronous) change is initiated by CO IMUX 24 when undisturbed service is needed during a configuration change. Sync change is particularly useful when an operator needs to take a link 16 down for maintenance or when a change in bandwidth is needed. Changing participating links 16 using a sync change is slower than a panic change, but ensures continuous undisturbed service.

CO IMUX 24 sends the following commands to CPE IMUX 26 to initiate a sync change:
(1) Vector Version command (op. code 0x01), arg=[vector_version]. Sent only when TDM configuration is changed;
(2) TDM Type command (op. code 0x02), arg=[tdm_type]. Sent only when TDM configuration is changed;
(3) TDM Rate command (op. code 0x03), arg=[tdm_rate]. Sent only when TDM configuration is changed;
(4) Sync Change command (op. code 0x05), arg=[participating_links]. Sent repeatedly at least until receipt of a Sync Change command (op. code 0x05) from CPE IMUX 26; the argument is a list, in the form of a bitmap, of the links 16 that will be part of the IMUX after the change;
(5) New Vector command (op. code 0x06), arg=[Tx_super_frame_countdown]. It is preferable that this countdown message be sent at least 3 times, i.e. it is preferable that the countdown variable in the argument field 52 be at least 2 the first time the countdown message is sent.

CPE IMUX 26, upon receiving a Sync Change command (op. code 0x05) and decoding the participating links and the vector version, TDM types and TDM rates, if these commands have been sent, sends the following commands to CO IMUX 24:
(1) Vector Version command (op. code 0x01), arg=[vector_version]. Sent only as reply to corresponding CO op. code;
(2) TDM Type command (op. code 0x02), arg=[tdm_type]. Sent only as reply to corresponding CO op. code;
(3) TDM Rate command (op. code 0x03), arg=[tdm_rate]. Sent only as reply to corresponding CO op. code;
(4) Sync Change command (op. code 0x05), arg=[participating_links]. Sent repeatedly at least until a New Vector command (op. code 0x06) has been received from CO IMUX 24; the argument is a list, in the form of a bitmap, of the links 16 that will be part of the IMUX after the change;
(5) New Vector command (op. code 0x06), arg=[Tx_super_frame_countdown]. This is a “reflex” countdown message, where the term “reflex” is used to indicate that this message is a “reflection” sent by the CPE IMUX in response to the CO IMUX, and to distinguish this reflex countdown messages sent by the CPE IMUX to the CO IMUX from the countdown messages sent by the CO IMUX to the CPE IMUX. It is preferable that this reflex countdown message be sent at least 3 times, i.e. it is preferable that the reflex countdown variable in the argument field be at least 2 the first time the reflex countdown message is sent.

CPE IMUX transmitter 10 starts working according to the new situation at the beginning of the Tx super-frame following the completion of the Tx countdown.

CPE IMUX receiver 12, upon receiving a New Vector command (op. code 0x06) from CO IMUX 24, starts counting down using an initial number taken from the countdown variable in the argument field of the New Vector command (op. code 0x06). CPE IMUX Receiver 12 starts working according to new situation at the beginning of the next Rx super-frame following the end of the Rx countdown.

CO IMUX Receiver 70, upon receiving a New Vector command (op. code 0x06) the from CPE-IMUX 26, starts counting down using an initial number taken from the reflex countdown variable in the argument field of the New Vector command (op. code 0x06). CO IMUX Receiver 70 starts working according to new situation at the beginning of the Rx super-frame following the Rx countdown reaching zero.

Although in this embodiment of the present invention the number of times the countdown and reflex countdown messages, i.e., New Vector commands (op. code 0x06), are sent is controlled using a countdown that proceeds by decrements of one to a final value of zero, alternative procedures may be used to substantially the same effect. Such alternative procedures include, but are not limited to, counting up rather than down, counting by increments or decrements of numbers other than one, counting to a final value other than zero, and sequential calculation of mathematical functions that reach a particular value. Control of the number of times the countdown and reflex countdown messages are sent by such alternative procedures is included in the scope of the present invention.

While the invention has been described with respect to a limited number of embodiments, it will be appreciated that many variations, modifications and other applications of the invention may be made.

What is claimed is:

1. A communication system comprising:
(a) a first receiver for receiving datagrams grouped in frames, said first receiver including:
(i) a recognizer for recognizing said datagrams; and
(ii) a frame regulator,
said recognizer operative to recognize a first string of said datagrams having a first predetermined pattern, said recognizer further operative to recognize a deviation, from said first pattern, of a second string of said datagrams, said recognizer further operative to recognize a third string of said datagrams having a second predetermined pattern, said recognizer further operative to recognize a deviation, from said second pattern, of a fourth string of said datagrams, said first receiver operative to set said frame regulator according to a time of arrival of one of said strings of said datagrams and according to a count of said datagrams between said second string and said fourth string, said frame regulator being operative to identify a position of one of said datagrams within one of said frames.

2. The system of claim 1, wherein said first pattern and said second pattern are identical.

3. The system of claim 1, wherein said first pattern and said second pattern differ from each other.

4. The system of claim 1, wherein said datagrams include bits, and wherein at least one of said patterns includes a plurality of contiguous groups of said bits, all said groups having a like number of bits, all said bits within any said group having like polarity, consecutive said groups of said bits alternating in polarity.

5. The system of claim 1, wherein said first receiver further includes:
(iii) a datagram counter operative to perform said count of said datagrams,
and wherein said first receiver is operative to initialize said datagram counter according to a time of said recognition of said second string.

6. The system of claim 1, wherein said first receiver further includes:
(iii) a frame length register,
and wherein said first receiver is operative to set said frame length register according to said count of said datagrams.

7. The system of claim 1, further comprising:
(b) a first transmitter;
(c) a second receiver, and
(d) a second transmitter,
and wherein said first receiver, after receiving said fourth string, is operative to cause said first transmitter to transmit a confirmation message, and wherein said second receiver, after receiving said confirmation message, is operative to cause said second transmitter to transmit user data to said first receiver.

8. The system of claim 7, wherein said first string, said second string, said third string and said fourth string are transmitted by said second transmitter.

9. The system of claim 1, wherein at least one of said frames includes at least one overhead datagram, and wherein said second string is within at least one of said at least one overhead datagrams, and wherein said fourth string is within at least one of said at least one overhead datagrams.

10. The system of claim 1, wherein said first receiver further includes:
(iii) an inverse multiplex receiver.

11. A method of synchronizing a receiver, of a communication system, that receives frames of datagrams, comprising the steps of:
(a) recognizing a first string of the datagrams having a first predetermined pattern;
(b) recognizing a deviation, from said first pattern, of a second string of the datagrams;
(c) recognizing a third string of the datagrams having a second predetermined pattern;
(d) recognizing a deviation, from said second pattern, of a fourth string of the datagrams, and
(e) identifying a position of a datagram within a frame according to a time of arrival of one of said strings of datagrams and according to a count of the datagrams between said second string and said fourth string.

12. The method of claim 11, wherein the method further comprises the step of:
(f) receiving the datagrams in an inverse multiplexed fashion.

13. A communication system comprising a receiver operative to receive datagrams grouped in frames, at least one said frame including at least one overhead datagram, and wherein said receiver is further operative to receive at least one command via at least one of said at least one overhead datagram.

14. The system of claim 13, wherein said at least one command is distributed among a plurality of said overhead datagrams.

15. The system of claim 13, wherein each said at least one overhead datagram is at a respective predetermined position within a said frame.

16. The system of claim 13, wherein at least one said overhead datagram includes a frame number.

17. The system of claim 13, wherein said receiver is further operative to receive a cyclic redundancy code for said at least one command via one of said at least one overhead datagram.

18. The system of claim 13, wherein said receiver is operative to receive a cyclic redundancy code for user data via at least one of said at least one overhead datagram.

19. The system of claim 13, wherein said receiver is operative to receive said datagrams in an inverse multiplexed fashion.

20. The system of claim 19, wherein one of said at least one command is a marker command, said receiver operative to use said marker command to measure a latency of a corresponding inverse multiplex link.

21. The system of claim 13, wherein one of said at least one command indicates which algorithm, from a predetermined group of algorithms, is to be used for calculating a parameter related to the communication system.

22. The system of claim 21, wherein said parameter includes a time slot vector.

23. The system of claim 13, wherein one of said at least one command indicates which time division multiplex protocol, from a predetermined group of time division multiplex protocols, is to be used on a link.

24. The system of claim 13, wherein one of said at least one command indicates a data rate to be used on a link.

25. The system of claim 13, wherein said receiver is operative to accept said at least one command only if said receiver receives said at least one command identically a predetermined number of times greater than one.

26. A method for communication comprising the steps of:
(a) receiving datagrams grouped in frames, at least one said frame including at least one overhead datagram, and
(b) receiving at least one command via at least one of said at least one overhead datagram.

27. The method of claim 26, wherein the method further comprises the step of:
(c) receiving the datagrams in an inverse multiplexed fashion.

28. A system comprising:
(a) a first device; and
(b) a second device communicating with said first device via at least one link,
wherein said first device is operative to transmit a command specifying a parameter related to said communicating, and wherein said second device, after having received said command, is operative to operate according to said parameter and transmit a confirmation message operative to confirm receipt by said second device of said command and wherein said first device, after having received said confirmation message, is operative to operate according to said parameter.

29. The system of claim 28, wherein said parameter includes a list of said at least one link participating in an inverse multiplex system.

30. The system of claim 29, wherein said second device is operative to compute, using said list of said at least one link, a time slot vector operative to organize reception of data from said at least one link.

31. The system of claim 28, wherein said command includes a bitmap.

32. A method for coordinating communication between a first device and a second device via at least one link, the method comprising the steps of:
(a) the first device transmitting a command specifying a parameter related to the communication;
(b) the second device receiving said command and operating according to said parameter;
(c) the second device transmitting a confirmation message operative to confirm receipt by the second device of said command; and
(d) the first device receiving said confirmation message and operating according to said parameter.

33. The method of claim 32, wherein said parameter includes a list of at least one link participating in an inverse multiplex system.

34. A system comprising:
(a) a first device; and
(b) a second device communicating with said first device via at least one link,
wherein said first device is operative to transmit a command specifying a parameter related to said communicating, said first device repeating said transmission of said command until said first device has received a confirmation message operative to confirm receipt by said second device of said command, and wherein said second device, after having received said command, is operative to transmit said confirmation message, and wherein said first device, after having received said confirmation message, is operative to repeatedly transmit a countdown message including a countdown variable, with said countdown variable decremented upon each repetition of said transmission of said countdown message until said countdown variable has a first predetermined value, said first device subsequently being operative to transmit data according to said parameter.

35. The system of claim 34, wherein said second device is operative to receive at least one said countdown message and wherein said second device is subsequently operative to repeatedly transmit a reflex countdown message including a reflex countdown variable, with said reflex countdown variable decremented upon each repetition of said transmission of said reflex countdown message, until said reflex countdown variable has a second predetermined value, said second device subsequently operative to transmit data according to said parameter.

36. The system of claim 35, wherein said first device, upon receiving a said reflex countdown message whose said reflex countdown variable has said second predetermined value, is subsequently operative to receive data according to said parameter.

37. The system of claim 34, wherein said second device, upon receiving a said countdown message whose said countdown variable has said first predetermined value, is subsequently operative to receive data according to said parameter.

38. The system of claim 34, wherein said parameter includes a list of said at least one link participating in an inverse multiplex system.

39. The system of claim 38, wherein said second device is operative to compute, using said list of said at least one link, a time slot vector operative to organize reception of data from said at least one link.

40. The system of claim 34, wherein said command includes a bitmap.

41. A method for coordinating communication between a first device and a second device via at least one link, the method comprising the steps of:
(a) the first device transmitting a command specifying a parameter related to the communication, the first device repeating said transmission of said command until the first device has received a confirmation message operative to confirm receipt by the second device of said command;
(b) the second device receiving said command and transmitting said confirmation message; and
(c) the first device receiving said confirmation message and the first device subsequently repeatedly transmitting a countdown message including a countdown variable, with said countdown variable decremented upon each repetition of said transmission of said countdown message until said countdown variable has a first predetermined value, the first device subsequently transmitting data according to said parameter.

42. The method of claim 41, wherein said parameter includes a list of at least one link participating in an inverse multiplex system.
